(19) United States
(12) Patent Application Publication
(10) Pub. No.: US 2013/0346405 A1
(43) Pub. Date: Dec. 26, 2013

(54) SYSTEMS AND METHODS FOR MANAGING DATA ITEMS USING STRUCTURED TAGS

(71) Applicant: Anthony Thomas Davis, Lancashire (GB)

(72) Inventor: Anthony Thomas Davis, Lancashire (GB)

(73) Assignee: AppSense Limited, Warrington (GB)

(21) Appl. No.: 13/530,940

(22) Filed: Jun. 22, 2012

(51) Int. Cl. G06F 17/30; G06F 15/16

(52) U.S. Cl. 707/736; 707/E17.005

(57) ABSTRACT

Systems and methods are provided for associating structured tags with files in a computer system. In one method, the method includes requesting a user, by the computer system, to provide the structured tag for the file, where the structured tag includes a tag type, a value type, and a tag value. The method can further include receiving the structured tag from the user, associating the structured tag and the file, and storing the association of the structured tag and the file in a non-transitory storage medium.

### CROSS-REFERENCE TO RELATED APPLICATIONS

This application is related to a co-pending U.S. patent application Ser. No. 13/457,150 entitled “SYSTEMS AND METHODS FOR AUTOMATICALLY ASSOCIATING TAGS WITH FILES IN A COMPUTER SYSTEM,” by Joseph Saib, filed on Apr. 26, 2012, which is expressly hereby incorporated by reference herein in its entirety.

### BACKGROUND

1. Technical Field

Disclosed systems and methods relate to associating multi-field tags to data items.

2. Description of the Related Art

Files in a computer system are often retrieved using search as a method for identifying the file, particularly in large collections of files where specifically identifying the file by file storage location becomes difficult. Search has limitations as well, stemming from its use of text strings to identify files, as many files contain identical or similar strings of text. This causes a large number of results to be returned for certain searches performed by a standard text search engine.

Some search systems attempt to mitigate the problem of ineffective textual searches by adding additional information to the files in the form of “tags.” Tags can include short strings of text that are assigned to individual files or chunks of content such as metadata. More than one tag may be assigned to a file. The assigned tags are chosen informally and personally by the user of the system, and do not necessarily relate to the file's location in a hierarchical storage system. Tagging was popularized by its use on the Web by websites such as Flickr and weblogs using the WordPress content management system.

However, tags are unstructured, which often limits the applicability and usefulness of the tags. For example, when a user associates a document with an author, “Michael James,” the user could choose to associate the document with any one of the following strings: “Michael,” “James,” “Michael James,” “M. James,” “Mike James,” or “MJ.” Therefore, when the user wants to retrieve all the documents associated with “Michael James” at a later point in time, the user has to retrieve all documents associated with each of these tag candidates to ensure that all documents relating to “Michael James” are retrieved. This process can be both time consuming and inefficient.

Therefore, there is a need in the art to provide alternative tagging systems for use on intranets and other networks. In particular, there is a need in the art to provide systems and methods for providing structured tags for documents.

Accordingly, it is desirable to provide methods and systems that overcome these and other deficiencies of the related art.

### SUMMARY

In accordance with the disclosed subject matter, systems, methods, and non-transitory computer-readable media are provided for associating a structured tag with a file in a computer system.

The disclosed subject matter includes a method for associating a structured tag with a file in a computer system, the method including requesting a user, by the computer system, to provide the structured tag for the file, where the structured tag includes a tag type, a value type, and a tag value. The method also includes receiving, by the computer system, the structured tag from the user; associating, by the computing system, the structured tag and the file; and storing, by the computer system, the association of the structured tag and the file in a non-transitory storage medium.

In one aspect, the method also includes sending the association of the tag and the file to a tag server, which is configured to maintain associations between a plurality of tags and files.

In one aspect, the method also includes providing a plurality of candidates for the tag type of the structured tag to the user, and requesting the user to select the tag type for the structured tag from the plurality of candidates for the tag type of the structured tag.

In one aspect, the method includes providing a plurality of candidates for the value type of the structured tag to the user, and requesting the user to determine the value type of the structured tag from the plurality of candidates for the value type of the structured tag.

In one aspect, the method of providing the plurality of candidates for the value type of the structured tag is performed in response to receiving the tag type of the structured tag from the user.

In one aspect, the method also includes determining the plurality of candidates for the value type based on the tag type determined by the user.

In one aspect, the method includes constraining a format of the tag value to a predetermined syntax based on the value type.

In one aspect, the method includes annotating the structured tag with a creator value, wherein the creator value comprises an identifier of the user that provided the structured tag.

The disclosed subject matter includes an apparatus for associating a structured tag with a file in a communications network. The apparatus includes one or more interfaces configured to provide communication with a server via a communication network, and a processor, in communication with the one or more interfaces. The processor is configured to run a module stored in memory. The module can be configured to request a user to provide the structured tag for the file, where the structured tag includes a tag type, a value type, and a tag value. The module can be further configured to receive the structured tag from the user, associate the structured tag and the file, and store the association of the structured tag and the file in a non-transitory storage medium.

In one aspect, the module in the apparatus is configured to send the association of the structured tag and the file to a tag server, which is configured to maintain associations between a plurality of tags and files.

In one aspect, the module in the apparatus is configured to provide a plurality of candidates for the tag type of the structured tag to the user, and to request the user to select the tag type for the structured tag from the plurality of candidates for the tag type.

In one aspect, the module in the apparatus is configured to provide a plurality of candidates for the value type of the structured tag to the user, and to request the user to determine the value type for the structured tag from the plurality of candidates for the value type.

In one aspect, the module in the apparatus is further configured to determine the plurality of candidates for the value type based on the tag type determined by the user.

In one aspect, the module in the apparatus is configured to constrain a format of the tag value to a predetermined syntax based on the value type.

In one aspect, the module in the apparatus is further configured to annotate the structured tag with a creator value, wherein the creator value comprises an identifier of the user that provided the structured tag.

The disclosed subject matter includes a non-transitory computer-readable medium having executable instructions. The executable instructions are operable to cause a device to request a user of the device to provide a structured tag for a file, where the structured tag includes a tag type, a value type, and a tag value. The executable instructions are also operable to cause the device to receive the structured tag from the user, to associate the structured tag and the file, and to store the association of the structured tag and the file in a non-transitory storage medium.

In one aspect, the computer-readable medium includes executable instructions operable to cause the device to send the association of the tag and the file to a tag server, which is configured to maintain associations between a plurality of tags and files.

In one aspect, the computer-readable medium includes executable instructions operable to cause the device to cause the device to provide a plurality of candidates for the value type of the structured tag to the user and to request the user to determine the value type for the structured tag from the plurality of candidates for the value type.

In one aspect, the computer-readable medium also includes executable instructions operable to cause the device to constrain a format of the tag value to a predetermined syntax based on the value type.

In one aspect, the computer-readable medium also includes executable instructions operable to cause the device to annotate the tag with a creator value, wherein the creator value comprises an identifier of the user that provided the structured tag.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a network connectivity diagram of a networked system in accordance with some embodiments of the disclosed subject matter.

FIGS. 2A-2B show representations of a tag in accordance with some embodiments of the disclosed subject matter.

FIG. 3 shows a flow diagram illustrating the process of associating a structured tag to a data item in accordance with certain embodiments of the disclosed subject matter.

FIG. 4 shows a flow diagram illustrating the process of searching a data item using structured tags in accordance with certain embodiments of the disclosed subject matter.

FIG. 5 illustrates a block diagram of a client device in accordance with certain embodiments of the disclosed subject matter.

FIG. 6 illustrates a block diagram of a server device in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are only for examples, and that it is contemplated that there are other systems and methods that are within the scope of the disclosed subject matter.

Users of present-day computer systems often use arbitrary textual keywords called tags as metadata for documents or arbitrary content objects. Tags can include short strings of text that are associated with individual files or chunks of content such as metadata. These tags help describe documents and allow others to find the documents later by browsing or searching. Tags do not need to be related to the content of the document; instead, they are chosen by the user of the system to facilitate understanding and retrieval. For this reason, often a document will have multiple tags, and several of these tags may be different synonyms for the same general concept. This reduces the need for a user to subsequently remember the exact phrasing used in the document for purposes of later retrieval.

Tags are different from intrinsic attributes of data items. In a traditional file system, data items, such as pictures, documents, email, or social media, are typically sorted and indexed using intrinsic attributes of the data items such as the date of creation, the file size, or the file name. Intrinsic attributes are different from tags for at least three reasons. First, each intrinsic attribute can only have a single value, whereas tags can include multiple values as discussed above. Second, intrinsic attributes of a data item can only be retrieved by accessing the data item, whereas a tag of a data item can be retrieved from a storage system separate from that of the data item. Therefore, retrieving the tag does not require accessing the entire data item, which improves the performance of the storage system. Lastly, intrinsic attributes of a data item can take on only a predetermined set of types. Intrinsic attributes of a data item are stored as part of the data item, for example, as a header. Therefore, the types of intrinsic attributes a are generally fixed and cannot be extended. For example, the file format limits the structure of the data item and does not provide the flexibility of types that can be associated with the intrinsic attributes.

Tags became popular as a result of their use on various websites. They possess many advantages. One advantage of tags is that they can be simply visualized to facilitate browsing and retrieval. For any arbitrary number of documents, all tags used by those documents can be listed to provide a simple visualization. Often, multiple documents share the same tag, and an additional layer of information can thus be made visible by increasing the size of the text for tags that are presented more than once in the collection of documents. The resultant visualization is called a tag cloud, and its visual appeal provides a visualization that is easy to create and that allows a user to browse a collection of documents.

Another advantage is that multiple tags may be applied to the same document. In storage systems where documents are organized in hierarchical file systems, it may be difficult or impossible to create an organization that is useful for all users. Tagging allows multiple users' organizational systems to coexist, facilitating document retrieval for all users.

Although tags can provide useful mechanisms for organizing data items, the unstructured nature of tags can limit the usefulness of tags. For example, in certain aspects, the unstructured nature of tags can be advantageous. Users can tag documents without worrying about the syntax, which can reduce the amount of time needed to associate a tag to a document. However, the unstructured nature of tags can create distinct tags even if the tags all relate to the same general concept. Therefore, providing efficient data item organization using unstructured tags requires analyzing the meaning of the tags, which can be challenging and computationally expensive.

The present disclosure describes systems and methods for providing structured tags in storage systems. In some embodiments, each tag can include three components: a tag type, a value type, and a tag value. In some embodiments, the tag type can associate a “meaning” to the tag. For example, a tag can be of an “author” type, which would indicate an author of the document; an “authorized personnel” type, which would indicate a person that is authorized to access the document; a “date of access” type, which would indicate the date on which the associated data item was accessed; or a “customer” type, which would indicate the customer for whom the document is created.

In some embodiments, the value type can indicate the type of values that can be carried by the tag value. For example, if the tag type is a “customer” type, then the value type can be a “customer name” type, indicating that the tag value should be a name of the user's customers. If the user has five customers, e.g., “Fred Smith,” “Michael Johnson,” “John Williams,” “Rachael Miller,” and “Julia Thomas,” then the value type can constrain the tag value to one of those five names.

In some embodiments, the value type can also be associated with a predetermined syntax. For example, if the value type is a “date” type, then the tag value may need to conform to a predetermined syntax of “month/day/year” (e.g., 6/7/2012), “month day, year” (e.g., Jun. 7, 2012,) or “month-day-year” (e.g., June-7-2012.)

In certain embodiments, the storage system can suggest or automatically assign tags to data items. Also, in some embodiments, the suggested or automatically assigned tags can be based on the tag type associated with the tag.

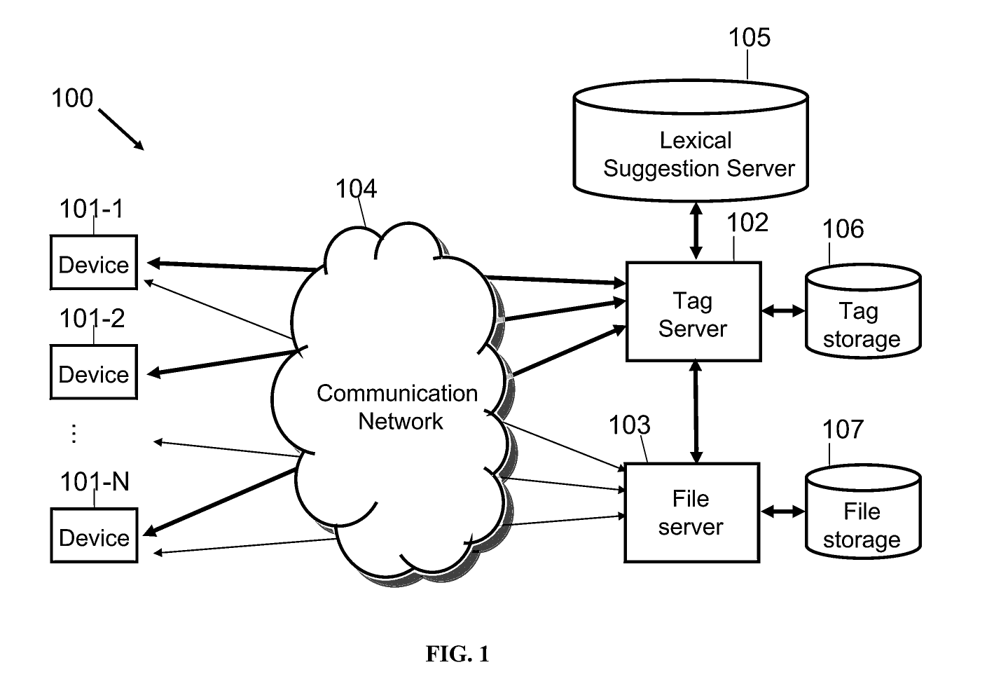

FIG. 1 is a network diagram in accordance with some embodiments of the disclosed subject matter. Network system 100 is a client/server system, in which at least one client 101 (e.g., devices 101-1, 101-2, . . . 101-n), a tag server 102, and a file server 103 communicate via a communication network 104. Tag server 102 can communicate with file server 103, a lexical suggestion server 105, and a tag storage 106. The device 101 can include a mobile device or user-operated device associated with a user. The device 101 can be any suitable device, including desktop computers, mobile computers, tablet computers, and cellular phones, including smartphones (e.g., Apple iPhones, RIM BlackBerry devices, or Android-based smartphones). Users can use the device 101 to perform searches for documents and files. In some embodiments, the device 101 can communicate directly with the file server 103 to retrieve the documents or files using intrinsic attributes. In other embodiments, the device 101 can also communicate with the tag server 102 to retrieve the documents or files using tags.

The file server 103 can retrieve the requested documents and files from a file storage 107, and send them to the device 101. The file server 103 may be a standard Microsoft Windows file server, web server, WebDAV server, or other file server. The file storage 107 can include a non-transitory computer readable medium. In some embodiments, the tag server 102 may provide proxy capability to intercept requests for files before the requests are sent to the file server 103. The file server 103 can directly send the files to the devices 101 in some embodiments. The tag server 102 may provide search capability, and this search capability may be provided via a webpage served by the tag server 102, via an enterprise search application such as Autonomy, or via a document management system such as iManage WorkSite, or another system, according to some embodiments.

The tag server 102 can communicate with lexical suggestion server 105, which may be a website such as WordNet, a local lexical analysis tool that analyzes textual data based on the corpus of documents available within the organization, or another system that can receive terms as input. The lexical suggestion server 105 can be within communication network 104, which may be the public Internet, may be a private intranet controlled by an organization or company, or may be another network. The tag server 102 can also communicate with a tag storage 106 to store or retrieve tags from the tag storage 106. The tag storage 106 can include a non-transitory computer readable medium. The non-transitory computer readable medium can include a flash memory, a magnetic disk drive, an optical drive, a programmable read-only memory (PROM), a read-only memory (ROM), a random access memory (RAM), or any other memory or combination of memories. In some embodiments, the tag storage 106 and the file storage 106 can be located in the same computer readable medium.

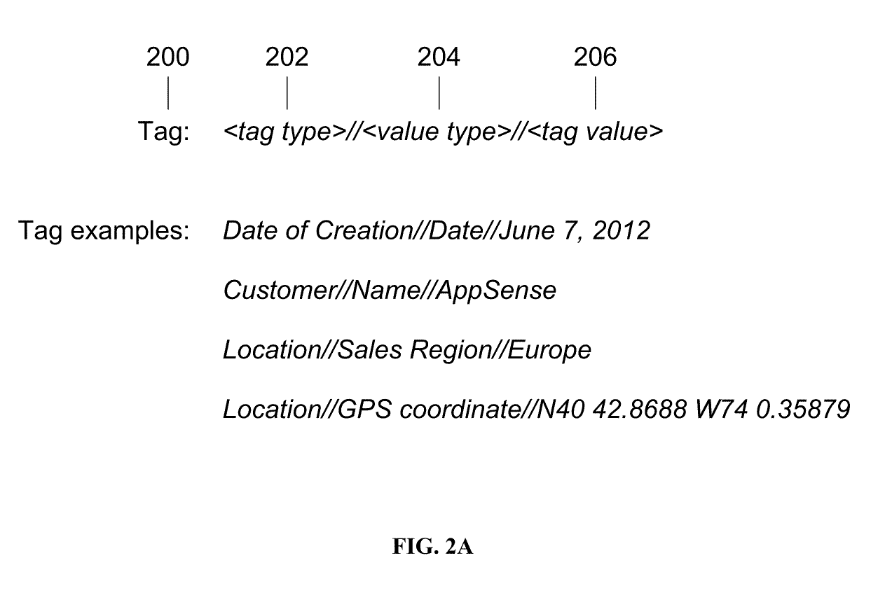

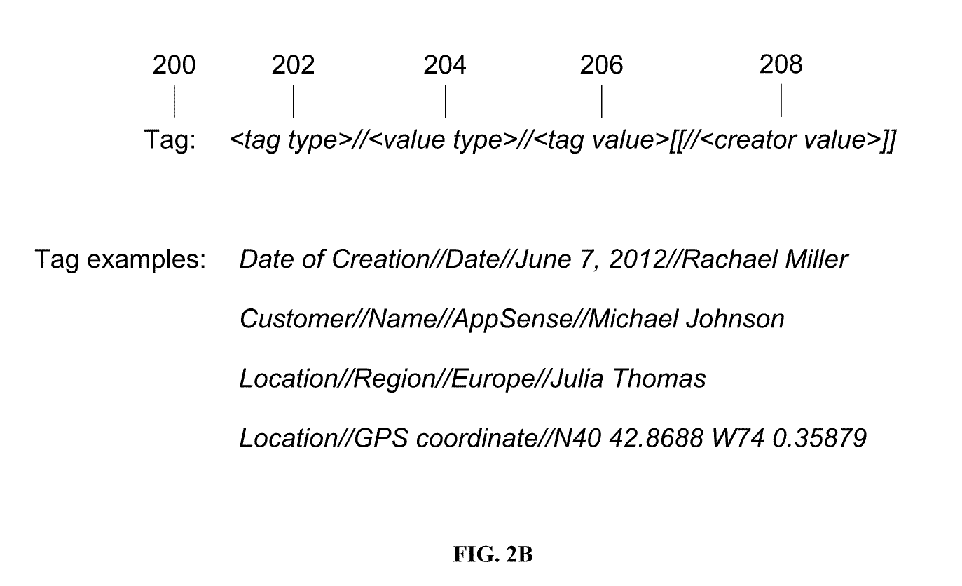

FIG. 2A shows a representation of a structured tag in accordance with some embodiments of the disclosed subject matter. A structured tag 200 can be represented using three fields (i.e., 3-tuple): a tag type 202, a value type 204, and a tag value 206. The tag type 202 can indicate the type of the tag. For example, the tag type 202 can be one of “Date of Creation,” “Customer,” “Location,” “Sales Data,” “Confidentiality,” “Phone number,” “Department,” “Author,” “Contact Information,” “Order Amount,” “Sales Team,” “Order,” or “Office.” The value type 204 can indicate the type of the value associated with the structured tag 200. For example, the value type 204 can be “Date,” “Name,” “Region,” “E-Mail Address,” “Mailing Address,” “Phone Number,” “Age,” “Number,” “Month,” “Year,” “GPS coordinate,” or “City.” The tag value 206 can indicate the actual value of the structured tag 200. For example, the tag value can be “AppSense,” “Europe,” “North America,” “November-23-2011,” “212-295-6443,” or “N40 42.8688 W74 0.35879.” FIG. 2A illustrates some examples of tags formatted according to the tag representation.

In some embodiments, certain tag types can only be associated with a predetermined set of value types. For example, the tag type “Date of Creation” can only be associated with a set of predetermined value types, including “Date,” “Month,” and “Year”; the tag type “Customer” can only be associated with a set of predetermined value types, including “Name” and “Age”; the tag type “Contact Information” can only be associated with a set of predetermined value types, including “E-Mail Address,” “Mailing Address,” and “Phone Number”; the tag type “Sales Data” can only be associated with a set of predetermined value types, including “Monthly,” “Team,” “Individual,” and “By Product”; the tag type “Confidentiality” can only be associated with a set of predetermined value types, including “Top Secret,” “Company Secret,” “Company Confidential,” and “Public”; and the tag type “Department” can only be associated with a set of predetermined value types, including “Research,” “Development,” “Sales,” “Market,” and “Legal.”

In some embodiments, certain tag values can only be associated with a predetermined value type. For example, a tag value “Jun. 7, 2012” can only be associated with the value type “Date”; a tag value “212-295-6443” can only be associated with the value type “Phone Number”; and a tag value “N40 42.8688 W74 0.35879” can only be associated with the value type “GPS coordinate.”

In some embodiments, certain value types can only be associated with a predetermined set of tag types. For example, if the value type is “Location,” then the tag type can be one of a predetermined set of tag types, including “Holiday attraction,” “Meeting,” “Apartment,” “Branch office,” “Appointment,” “Conference,” and “Store.”

In some embodiments, the tag value 206 can be constrained to be one of the predetermined set of values. The predetermined set of values can depend on the value type 204 associated with the tag value 206. For example, if the value type 204 is “Region,” then the tag value 206 can be constrained to be one of “Asia,” “Europe,” “North America,” “South America,” or “Africa”; if the value type 204 is “Month,” then the tag value 206 can be constrained to be one of “January,” “February,” “March,” “April,” “May,” “June,” “July,” “August,” “September,” “October,” “November,” or “December”; if the value type 204 is “Staff,” then the tag value 206 can be constrained to be one of “Peter,” “Julia,” “Michael,” and “Anne”; and if the value type 204 is “Customer,” then the tag value 206 can be constrained to be one of “Barclays,” “Credit Suisse,” “BNP Paribas,” “UBS,” “JP Morgan,” and “Goldman Sachs.”

In some embodiments, a tag value 206 may be formatted according to a predetermined syntax. The predetermined syntax can depend on the value type 204. For example, the tag value 206 of the “Date” value type can be formatted as “Month-Day-Year”; the tag value 206 of the “Number” value type can be formatted as “1,234,567.”

FIG. 2B shows another representation of a structured tag in accordance with some embodiments of the disclosed subject matter. The structured tag 200 can include a tag type 202, a value type 204, and a tag value 206, as discussed above, but can optionally include a creator value 208, indicating the user that created the tag. This representation allows different structured tags to be associated for different users.

In some embodiments, a structured tag can include any suitable number of fields to represent the desired information. For example, a structured tag can include five, six, or more fields, instead of three or four fields. In some embodiments, a structured tag can include any type of fields. For example, instead of the tag type field, a structured tag can include a <file type> field. In some embodiments, the fields in the structured tags can be ordered in any manner. In one example, a structured tag can be ordered as <tag type>//<tag value>//<value type>; in another example, a structured tag can be ordered as <tag value>//<value type>//<tag type>. In some embodiments, all data items or certain types of data items can have the same fields, different fields, or some combination thereof. In other embodiments, a structured tag can include any suitable tag types, any suitable value types, and/or combination of tag types and value types.

In some embodiments, a structured tag 200 can be used to sort or search for data items. A tag server 102 can be configured to maintain a list of data items and the associated structured tags. Each entry in the tag server 102 can be formatted as follows: (data item+{Tags}). The {Tags} field in the entry can include one or more tags associated with the data item. Suppose that a tag server 102 maintains the following entries:
(Fred+{Sales Team//Region//Europe, Order//Date//January-1-2010, Order amount//Number//1500})
(John+{Sales Team//Region//North America, Order//Date//January-3-2011, Order amount//Number//1100})
(Julia+{Sales Team//Region//Europe, Order//Date//March-5-2011, Order amount//Number//100})
(Rachael+{Sales Team//Region//North America, Order//Date//July-7-2011, Order amount//Number//3020})
(William+{Sales Team//Region//Asia, Sales Team//Region//Europe, Sales Team//Region//North America, Order//Date//November-23-2011, Order amount//Number//143020})
   Fred is associated with three structured tags: “Sales Team//Region//Europe,” “Order//Date//January-1-2010,” and “Order amount//Number//1500”; William is associated with five structured tags: “Sales Team//Region//Asia,” “Sales Team//Region//Europe,” “Sales Team//Region//North America,” “Order//Date//November-23-2011,” and “Order amount//Number//143020.” Note that William has three structured tags with the same tag type “Sales Team.”

If a user wants to retrieve data items, the user can provide a data item search request to the tagging system. If the user is interested in sales personnel associated with Europe, who has also received an order after Jan. 1, 2011, the user can specify, in the data item search request, {Sales Team//Region//Europe}, {Order//Date//later than January-1-2011} as tag constraints. When the tagging system receives the data item search request, the tagging system would search through the structured tags in the database to find all entries satisfying the tag constraints, and would return the following entries as the search result:
(Julia+{Sales Team//Region//Europe, Order//Date//March-5-2011, Order amount//Number//100})
(William+{Sales Team//Region//Asia, Sales Team//Region//Europe, Sales Team//Region//North America, Order//Date//November-23-2011, Order amount//Number//143020})
   Even though William is associated with more than one sales team, because William is associated with the sales team in Europe, the tag server 102 returns William as a match. In some embodiments, when structured tags are associated with creator values 208, the user can also specify that the user wants to retrieve documents created by a particular creator.

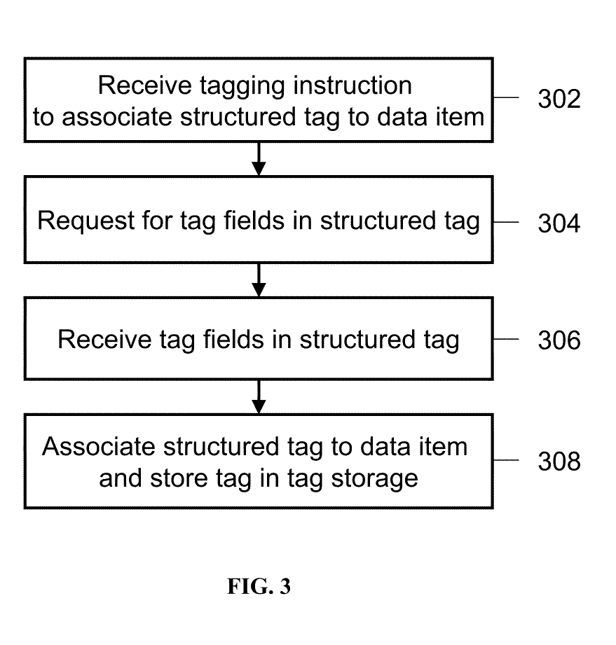

FIG. 3 shows a flow diagram illustrating the process of associating a structured tag to a data item in accordance with certain embodiments of the disclosed subject matter. In some embodiments, these steps can be carried out by a combination of a tag server 102 and a mobile device 101. In some embodiments, these steps can be carried out entirely by a mobile device 101. In other embodiments, these steps can be carried out entirely by a tag server 102. These steps are illustrated using an embodiment in which some of the steps are carried out by the mobile device 101 and some of the steps are carried out by the tag server 102.

In step 302, the mobile device 101 receives a tagging request from a user, requesting that a data item be associated with a structured tag. The user can provide the tagging request by clicking on a button or an option from a tool bar. The user can also provide the tagging request by responding to a prompt provided by the mobile device 101, when the user creates or stores a data item.

In step 304, in response to receiving the tagging request, the mobile device 101 can request the user to provide one or more tag fields of a structured tag. In one example, the mobile device 101 can request the user to provide one or more of a tag type, a value type, and a tag value. In another example, the mobile device 101 can request the user to provide any other suitable fields and/or combination of fields for the structured tag. In response, in step 306, the mobile device 101 can receive, from the user, the one or more tag fields.

In step 308, the mobile device 101 can send a tag association request to the tag server 102. The tag association request can include the structured tag and the data item identifier, requesting the tag server 102 to associate the structured tag with the data item identifier and store the association in a tag storage 106.

In some embodiments, in step 304, the mobile device 101 can provide, to the user, tag suggestions, from which the user can select the desired tag. The tag suggestions can include one or more candidates for the tag fields, for example, the tag type, the value type, and/or the tag value.

In one aspect, the mobile device 101 can provide the tag suggestions locally. For example, the mobile device 101 can maintain, in a local non-transitory storage medium, a set of predetermined candidates for the tag type, the value type, and/or the tag value. When the user requests to tag a file, the mobile device 101 can provide these predetermined candidates to the user as suggested tags.

In another aspect, the mobile device 101 can receive tag suggestions from a tag server 102. The tag server 102 can provide tag suggestions to the mobile device 101 in at least two different ways. First, the tag server 102 can maintain a set of predetermined candidates for the tag type, the value type, and/or the tag value, and provide these predetermined candidates upon receiving a request from the mobile device 101. Second, the tag server 102 can derive tag suggestions based on the file being tagged. For example, the tag server 10 can derive tag suggestions based on files similar to the file being tagged. If the file being tagged is similar to a reference file and if the reference file has tags associated with it, then the tag server 102 can provide the reference file's tags as tag suggestions for the file being tagged. In another example, the tag server 102 may derive tag suggestions based on the structured tags that were previously provided by other users. If the file being tagged was previously tagged by other users, the tag server 102 can provide those structured tags as tag suggestions for the current user.

In some embodiments, steps 304 and 306 can occur interactively. For example, the mobile device 101 can provide a plurality of suggested tag types and request the user to select a tag type from the plurality of suggested tag types. Once the user selects the tag type for the structured tag, the mobile device 101 can identify a plurality of candidates for the value type. In one aspect, the identification of the value type candidates can depend on the selected tag type. Once the value type candidates are identified, the mobile device 101 can provide the identified value types to the user and request the user to select one of the identified value types for the structured tag. In one aspect, the mobile device 101 can provide the user with an option to discard the value type candidates and directly input the value type for the structured tag. Once the user provides the value type for the structured tag, the mobile device 101 can identify candidates for the tag value. In one aspect, the identification of the tag value candidates can depend on the selected value type. Once the tag value candidates are identified, the mobile device 101 can provide the tag value candidates to the user and request the user to select one of the tag value candidates for the structured tag. In one aspect, the mobile device 101 can provide the user with an option to discard the tag value candidates and directly input the tag value for the structured tag.

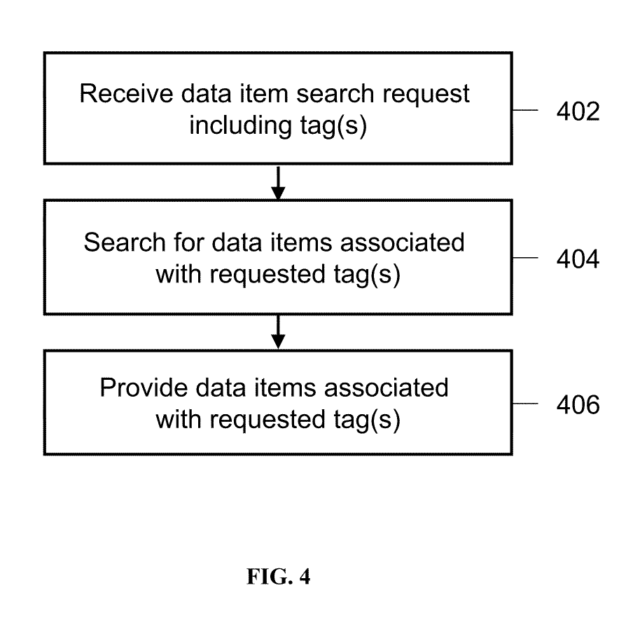

FIG. 4 shows a flow diagram illustrating the process of searching for a data item in a database in accordance with certain embodiments of the disclosed subject matter. In some embodiments, these steps can be carried out by a combination of a tag server 102 and a mobile device 101. In some embodiments, these steps can be carried out entirely by a mobile device 101. In other embodiments, these steps can be carried out entirely by a tag server 102. These steps are illustrated using an embodiment in which some of the steps are carried out by the mobile device 101 and some of the steps are carried out by the tag server 102.

In step 402, the mobile device 101 receives a data item search request from a user. The data item search request can include one or more structured tags, indicating that the user wants to retrieve all data items associated with all of the identified structured tags. In some embodiments, the user can specify the structured tags in the data item search request in an interactive manner. For example, the mobile device 101 can provide a plurality of suggested tag types and request the user to select a tag type from the plurality of suggested tag types. Once the user selects the tag type for the structured tag, the mobile device 101 can identify a plurality of candidates for the value type. In one aspect, the identification of the value type candidates can depend on the selected tag type. Once the value type candidates are identified, the mobile device 101 can provide the identified value types to the user and request the user to select one of the identified value types for the structured tag. In one aspect, the mobile device 101 can provide the user with an option to discard the value type candidates and directly input the value type for the structured tag. Once the user provides the value type for the structured tag, the mobile device 101 can identify candidates for the tag value. In one aspect, the identification of the tag value candidates can depend on the selected value type. Once the tag value candidates are identified, the mobile device 101 can provide the tag value candidates to the user and request the user to select one of the tag value candidates for the structured tag. In one aspect, the mobile device 101 can provide the user with an option to discard the tag value candidates and directly input the tag value for the structured tag.

In step 404, the mobile device 101 can relay the data item search request to the tag server 102. In response, the tag server 102 searches for all data items having the requested structured tag(s), and in step 406, the tag server 102 provides the list of data items associated the requested tag(s) to the mobile device 101. The mobile device 101 would provide the list to the user.

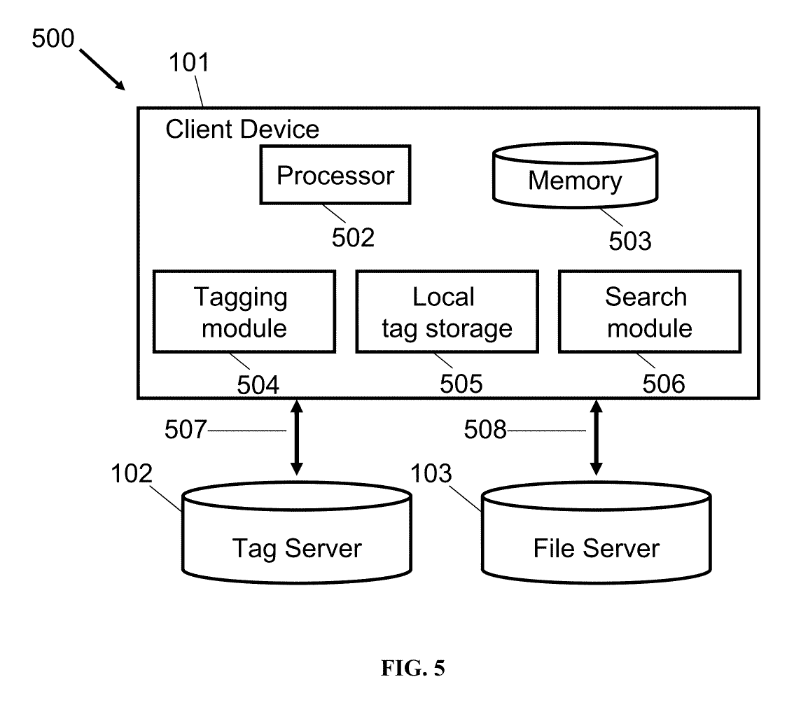

FIG. 5 is a block diagram of a client device in accordance with certain embodiments of the disclosed subject matter. The block diagram 500 shows a client device 101, which includes processor 502, memory 503, a tagging module 504, a local tag storage 505, and a search module 506. The client device 101 is connected to the tag server 102 via the interface 507 and the file server 103 via the interface 508. The interfaces 507 and 508 are shown as separate physical interfaces but may be the same physical interface.

In some embodiments of the disclosed subject matter, the client device 101 can include additional modules, fewer modules, or any other suitable combination of modules that perform any suitable operation or combination of operations. The memory 503 can be a non-transitory computer readable medium, flash memory, a magnetic disk drive, an optical drive, a programmable read-only memory (PROM), a read-only memory (ROM), or any other memory or combination of memories. The software runs on a processor 502 capable of executing computer instructions or computer code. The processor 502 might also be implemented in hardware using an application specific integrated circuit (ASIC), programmable logic array (PLA), field programmable gate array (FPGA), or any other integrated circuit.

At least interfaces 507 and 508 provide an input and/or output mechanism to communicate over a network. The interfaces 507 and 508 enable communication with servers, as well as other network nodes in the communication network. The interfaces 507 and 508 are implemented in hardware to send and receive signals in a variety of mediums, such as optical, copper, and wireless, and in a number of different protocols some of which may be non-transient. The interfaces 507 and 508 may be the same interface.

The client device 101 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, Apple iOS, RIM BlackBerry OS, Windows Mobile, Linux, HP WebOS, and Android. The screen may be a touch screen that is used to input data to the mobile device, in which case the screen can be used instead of the full keyboard. The user equipment can also keep global positioning coordinates, profile information, or other location information.

The client device 101 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 101 is configured with one or more processors 502 that process instructions and run software that may be stored in memory. The processor 502 also communicates with the memory and interfaces to communicate with other devices. The processor 502 can be any applicable processor such as a system-on-a-chip that combines a CPU, an application processor, and flash memory. The client device 101 can also provide a variety of user interfaces such as a keyboard, a touch screen, a trackball, a touch pad, and/or a mouse. The client device 101 may also include speakers and a display device in some embodiments.

When searching for one or more documents using search terms, or when assigning tags, the tagging module 504 may perform several functions. These functions include: identifying tag types, identifying value types, identifying tag values, identifying whether user intervention is required, analyzing files and their contents to identify tag values, correlating one set of tags with another set of tags to improve retrievability and consistency, and other functions. The tagging module 504 receives requests to assign tags as well. When tags are assigned, they can be stored in the local tag storage 505. Storing may occur in the form of an association between a file and a tag. They may also occur in the form of associations from between a file and a plurality of tags. Other associations may also be contemplated, in some embodiments. The local tag storage 505 may be synchronized with the tag server 102, periodically or on an as-needed basis or at other times. The search module 506 provides a user interface for searching for one or more files, and interfaces with the tagging module 504. The search module 506 or the tagging module 504 communicates with the file server 103 to retrieve requested documents.

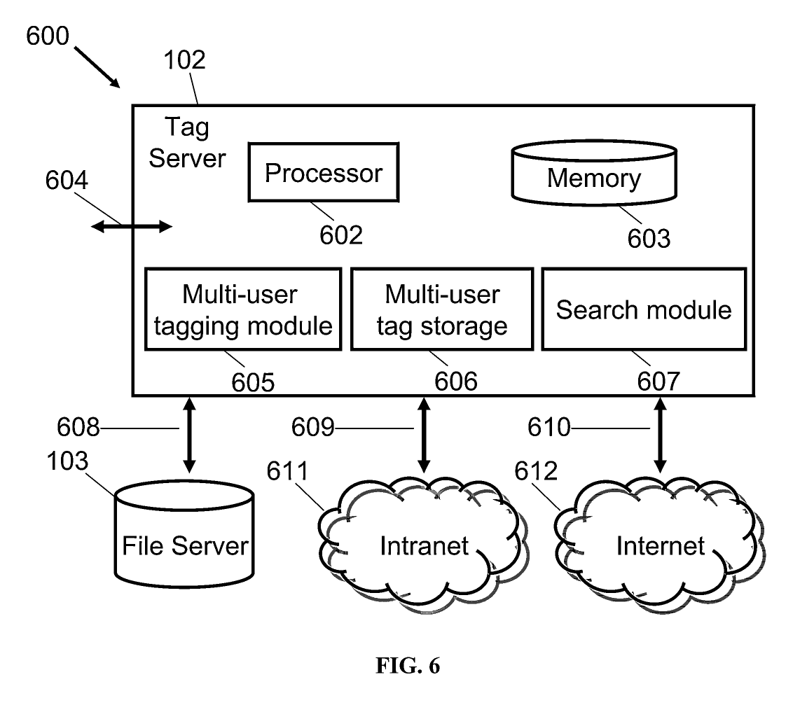

FIG. 6 is a block diagram of a tag server device, in accordance with some embodiments of the disclosed subject matter. The tag server device 102 includes a processor 602, memory 603, a multi-user tagging module 605, a multi-user tag storage 606, and a search module 607. The tag server 102 can communicate with client device 101 (not shown) via interface 604. The tag server 102 may communicate with the file server 103 via interface 608. The tag server 102 may communicate with intranet 611 via interface 609. The tag server 102 may communicate with Internet 612 via interface 610. The tag server can communicate with intranet 611 or Internet 612 to reach client devices 101 or other servers, such as a file server 103, another tag server, or a lexical suggestion server 105.

As described for block diagram 600, a multi-user tagging module 605, a multi-user tag storage 606, and a search module 607 are provided. The operation of these modules is similar to the operation of the analogous modules in block diagram 500, but their functions are performed across multiple users and on any and all files available to the tag server 102, which may be a superset of the files available to each local device. The multi-user tagging module 605 thus corresponds to the tagging module 504 and provides tagging modules for one or more users and uses tags that are used by all users; the multi-user tag storage 606 corresponds to the local tag storage 505 and stores tags used by all users; and the search module 607 corresponds to the search module 506 and provides search for documents stored on behalf of all users or that are made accessible on the network. Additionally, tags may be requested from the multi-user tag service 605 by the client devices 101, in order to provide consistent tags throughout an organization consisting of many client devices that provide and include tagging modules. Additionally, more resources for identifying tags, particularly based on lexical analysis, may be available on intranet 611 and Internet 612, as described elsewhere herein.

The processor 602 performs processing for one or more modules as disclosed in this specification. The memory 603 provides temporary storage of data as required by the processor 602. The memory 604 can be a non-transitory computer readable medium, flash memory, a magnetic disk drive, an optical drive, a programmable read-only memory (PROM), a read-only memory (ROM), or any other memory or combination of memories. The software runs on a processor 602 capable of executing computer instructions or computer code. The processor 602 may also be implemented in hardware using an application specific integrated circuit (ASIC), programmable logic array (PLA), field programmable gate array (FPGA), or any other integrated circuit.

Although the processor 602 performs one or more steps described in the flow diagram of FIGS. 3-4, multiple sub-modules may exist within either the software or hardware of tag server 102 that provide supporting functionality.

The tag server 102 can operate using an operating system (OS) software. In some embodiments, the OS software is based on a Linux software kernel and runs specific applications in the tag server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The tag server's software can be divided into a series of tasks that perform specific functions. These tasks communicate with each other as needed to share control and data information throughout the tag server 102. A task can be a software process that performs a specific function related to system control or session processing. Three types of tasks operate within the tag server 102 in some embodiments: critical tasks, controller tasks, and manager tasks. The critical tasks control functions that relate to the tag server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the tag server 102 include a system initiation task subsystem, a high availability task subsystem, a shared configuration task subsystem, and a resource management subsystem.

The system initiation task subsystem is responsible for starting a set of initial tasks at system startup and providing individual tasks as needed. A high availability task subsystem works in conjunction with the recovery control task subsystem to maintain the operational state of the tag server 102 by monitoring the various software and hardware components of the tag server 102. A recovery control task subsystem is responsible for executing a recovery action for failures that occur in the tag server 102 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the tag server 102 with an ability to set, retrieve, and receive notification of server configuration parameter changes and is responsible for storing configuration data for the applications running within the tag server 102. A resource management subsystem is responsible for assigning resources (e.g., processor and memory capabilities) to tasks and for monitoring the task's use of the resources.

In some embodiments, the tag server 102 can reside in a data center and form a node in a cloud computing infrastructure. The tag server 102 can also provide services on demand. A module hosting a client is capable of migrating from one server to another server seamlessly, without causing program faults or system breakdown. The tag server 102 in the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. For example, while this disclosure discusses search in detail, other methods for retrieving documents may also provide embodiments that are in accordance with the disclosed subject matter, such as retrieval via browsing, retrieval using a hierarchical file structure, retrieval using a tag cloud, etc. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for associating a structured tag with a file in a computer system, the method comprising:
requesting a user, by the computer system, to provide the structured tag for the file, the structured tag comprising a tag type, a value type, and a tag value;
receiving, by the computer system, the structured tag from the user;
associating, by the computing system, the structured tag and the file; and
storing, by the computer system, the association of the structured tag and the file in a non-transitory storage medium.

2. The method of claim 1, further comprising sending the association of the tag and the file to a tag server, which is configured to maintain associations between a plurality of tags and files.

3. The method of claim 1, further comprising:
providing a plurality of candidates for the tag type of the structured tag to the user; and
requesting the user to select the tag type for the structured tag from the plurality of candidates for the tag type of the structured tag.

4. The method of claim 3, further comprising:
providing a plurality of candidates for the value type of the structured tag to the user; and
requesting the user to determine the value type of the structured tag from the plurality of candidates for the value type of the structured tag.

5. The method of claim 4, wherein providing the plurality of candidates for the value type of the structured tag is performed in response to receiving the tag type of the structured tag from the user.

6. The method of claim 5, further comprising determining the plurality of candidates for the value type based on the tag type determined by the user.

7. The method of claim 4, further comprising constraining a format of the tag value to a predetermined syntax based on the value type.

8. The method of claim 1, further comprising annotating the structured tag with a creator value, wherein the creator value comprises an identifier of the user that provided the structured tag.

9. An apparatus for associating a structured tag with a file in a communications network, the apparatus comprising:
one or more interfaces configured to provide communication with a server via a communication network; and
a processor, in communication with the one or more interfaces, and configured to run a module stored in memory that is configured to:
request a user to provide the structured tag for the file, the structured tag comprising a tag type, a value type, and a tag value;
receive the structured tag from the user;
associate the structured tag and the file; and
store the association of the structured tag and the file in a non-transitory storage medium.

10. The apparatus of claim 9, wherein the module is further configured to send the association of the structured tag and the file to a tag server, which is configured to maintain associations between a plurality of tags and files.

11. The apparatus of claim 9, wherein the module is further configured to:
provide a plurality of candidates for the tag type of the structured tag to the user; and
request the user to select the tag type for the structured tag from the plurality of candidates for the tag type.

12. The apparatus of claim 11, wherein the module is further configured to:
provide a plurality of candidates for the value type of the structured tag to the user; and
request the user to determine the value type for the structured tag from the plurality of candidates for the value type.

13. The apparatus of claim 12, wherein the module is further configured to determine the plurality of candidates for the value type based on the tag type determined by the user.

14. The apparatus of claim 12, wherein the module is further configured to constrain a format of the tag value to a predetermined syntax based on the value type.

15. The apparatus of claim 12, wherein the module is further configured to annotate the structured tag with a creator value, wherein the creator value comprises an identifier of the user that provided the structured tag.

16. A non-transitory computer-readable medium having executable instructions operable to cause a device to:
request a user of the device to provide a structured tag for a file, the structured tag comprising a tag type, a value type, and a tag value;
receive the structured tag from the user;
associate the structured tag and the file; and
store the association of the structured tag and the file in a non-transitory storage medium.

17. The computer-readable medium of claim 16, further comprising executable instructions operable to cause the device to send the association of the tag and the file to a tag server, which is configured to maintain associations between a plurality of tags and files.

18. The computer-readable medium of claim 16, further comprising executable instructions operable to cause the device to provide a plurality of candidates for the value type of the structured tag to the user and to request the user to determine the value type for the structured tag from the plurality of candidates for the value type.

19. The computer-readable medium of claim 18, further comprising executable instructions operable to cause the device to constrain a format of the tag value to a predetermined syntax based on the value type.

20. The computer-readable medium of claim 16, further comprising executable instructions operable to cause the device to annotate the tag with a creator value, wherein the creator value comprises an identifier of the user that provided the structured tag.
